(19) United States
(12) Patent Application Publication
(10) Pub. No.: US 2019/0272536 A1
(43) Pub. Date: Sep. 5, 2019

(54) AUTOMATIC TRANSACTION DEVICE AND AUTOMATIC TRANSACTION SYSTEM

(71) Applicant: Oki Electric Industry Co., Ltd., Tokyo (JP)

(72) Inventor: Motomitsu KIKUCHI, Tokyo (JP)

(73) Assignee: Oki Electric Industry Co., Ltd., Tokyo (JP)

(21) Appl. No.: 16/461,266

(22) PCT Filed: Oct. 18, 2017
(86) PCT No.: PCT/JP2017/037749

§ 371 Date: May 15, 2019

(30) Foreign Application Priority Data
Nov. 22, 2016 (JP) 2016-226657

(51) Int. Cl. G06Q 20/38; G06Q 20/40; G07D 11/00

(52) U.S. Cl. CPC G06Q 20/381; G06Q 20/4014; G07D 11/0087; G06Q 20/405; G06Q 20/407

(57) ABSTRACT

An automatic transaction device that performs an exchange transaction to exchange cash of a first currency to cash of a second currency, the automatic transaction device includes: a reader section that reads medium-held information held on a medium and including at least information to identify an individual user; a first storage section that stores separately for each user a transaction amount of the exchange transaction that has been performed; and a controller that, based on the medium-held information read using the reader section, acquires a past transaction amount for the corresponding user stored in the first storage section, and performs control to cancel a current exchange transaction according to whether or not a total of the past transaction amount plus a total of a transaction amount of a current exchange transaction exceeds a predetermined upper limit amount.

### TECHNICAL FIELD

This application claims priority from Japanese Patent Application No. 2016-226657, filed on Nov. 22, 2016, the disclosure of which is incorporated in its entirety by reference herein.

The present disclosure relates to an automatic transaction device and an automatic transaction system, and may, for example, be applied to a foreign currency exchange device and a foreign currency exchange system capable of exchanging foreign currency.

### BACKGROUND ART

Hitherto, foreign currency exchange devices perform transaction processing (i.e., exchanging domestic currency for foreign currency, or exchanging foreign currency for domestic currency) (see Japanese Patent Application Laid-Open (JP-A) No. 2008-250540).

### SUMMARY OF INVENTION

### Technical Problem

Certain countries set a daily transaction limit amount for foreign currency exchange. In such cases, such conventional foreign currency exchange devices are not capable of setting a limit amount, and a user could potentially exchange more than the limit amount.

Accordingly, an automatic transaction device is desired that is capable of, when foreign currency exchange limits are set, limiting exchange transactions by a user according to the foreign currency exchange limits.

### Solution to Problem

A first aspect of the present disclosure is an automatic transaction device that performs an exchange transaction to exchange cash of a first currency to cash of a second currency. The automatic transaction device includes (1) a reader section that reads medium-held information held on a medium and including at least information to identify an individual user, (2) a first storage section that stores separately for each user a transaction amount of the exchange transaction that has been performed, and (3) a controller that, based on the medium-held information read using the reader section, acquires a past transaction amount for the corresponding user stored in the first storage section, and performs control to cancel a current exchange transaction according to whether or not a total of the past transaction amount plus a total of a transaction amount of a current exchange transaction exceeds a predetermined upper limit amount.

A second aspect of the present disclosure is an automatic transaction system including plural automatic transaction devices that perform an exchange transaction to exchange cash of a first currency to cash of a second currency, and a management device. In the system, (2) each of the automatic transaction devices includes (2-1) a reader section that reads medium-held information held on a medium and including at least information to identify an individual user, (2-2) a first communication section that transmits the medium-held information and information indicating a transaction amount of a current exchange transaction to the management device, and that receives determination information from the management device to determine whether or not to continue with the current exchange transaction, and (2-3) a controller that performs control to cancel a current exchange transaction based on the determination information. In the system, (3) the management device includes (3-1) a second communication section that receives the medium-held information and the information indicating a transaction amount of a current exchange transaction from each of the automatic transaction devices, and that transmits the determination information to each of the automatic transaction devices, (3-2) a second storage section that stores separately for each user a transaction amount of the exchange transaction that has been performed using any of the automatic transaction devices, and (3-3) a determination section that, based on the medium-held information, acquires a past transaction amount for the corresponding user stored in the second storage section, and determines whether or not to continue with a current exchange transaction depending on whether or not a total of the past transaction amount plus a total of a transaction amount of a current exchange transaction amount exceeds a predetermined upper limit amount.

### Effects of the Invention

The present disclosure is capable of limiting exchange transactions by a user according to foreign currency exchange limits set by country.

### BRIEF DESCRIPTION OF DRAWINGS

FIG. 1 is a block diagram illustrating configuration of a foreign currency exchange device of a first exemplary embodiment.

FIG. 2 is an explanatory diagram illustrating an example of saved individual user exchange amount data of the first exemplary embodiment.

FIG. 3 is a flowchart illustrating exchange transaction (buying transaction) processing of the foreign currency exchange device of the first exemplary embodiment.

FIG. 4 is a flowchart illustrating exchange transaction (selling transaction) processing of the foreign currency exchange device of the first exemplary embodiment.

FIG. 5 is a block diagram illustrating an overall configuration of a foreign currency exchange system of a second exemplary embodiment.

FIG. 6 is a block diagram illustrating configuration of a management device of the second exemplary embodiment.

FIG. 7 is a flowchart illustrating exchange transaction (buying transaction) processing of a foreign currency exchange device of the second exemplary embodiment.

FIG. 8 is a flowchart illustrating exchange transaction (selling transaction) processing of the foreign currency exchange device of the second exemplary embodiment.

FIG. 9 is a block diagram illustrating configuration of a storage unit of a management device of a third exemplary embodiment.

FIG. 10 is a flowchart illustrating exchange transaction (buying transaction) processing of a foreign currency exchange device of the third exemplary embodiment.

FIG. 11 is a flowchart illustrating exchange transaction (selling transaction) processing of the foreign currency exchange device of the third exemplary embodiment.

### DESCRIPTION OF EMBODIMENTS

### (A) First Exemplary Embodiment

Detailed explanation follows regarding a first exemplary embodiment of an automatic transaction device and an automatic transaction system of the present disclosure, with reference to the drawings. Note that the present exemplary embodiment describes an example in which an automatic transaction device of the present disclosure is applied to a foreign currency exchange device.

### (A-1) Configuration of the First Exemplary Embodiment

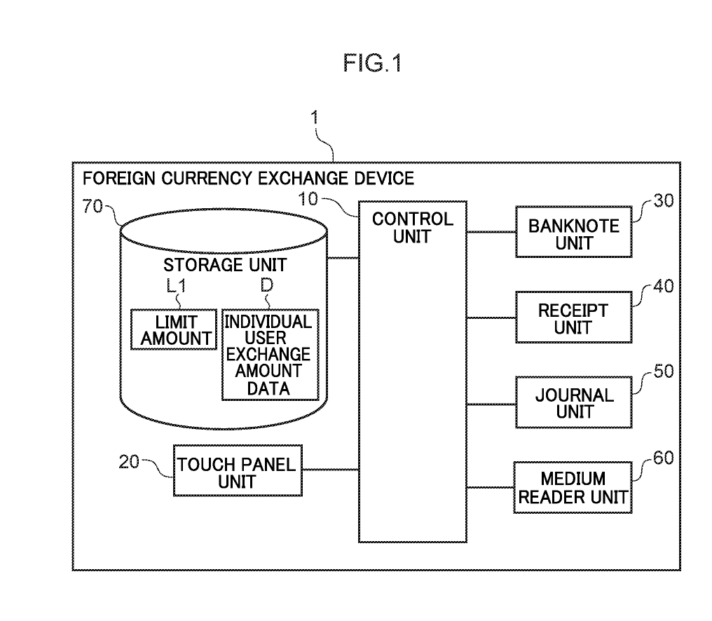

FIG. 1 is a block diagram illustrating configuration of a foreign currency exchange device of the first exemplary embodiment.

In the present exemplary embodiment, a foreign currency exchange device 1 is capable of performing exchange transactions between a domestic currency, this being the currency of the country in which the device is installed (JPY if installed in Japan) and a foreign currency, this being the currency of another country (for example US dollars (USD)). Note that the type and number of currencies capable of being exchanged by the foreign currency exchange device 1 are not limited. In the following explanation, a foreign currency exchange transaction to exchange from the domestic currency to a foreign currency using the foreign currency exchange device 1 corresponds to a “selling transaction”, and a foreign currency exchange transaction to exchange from the foreign currency to the domestic currency using the foreign currency exchange device 1 corresponds to a “buying transaction”. The domestic currency and the foreign currency are examples of a first currency and a second currency.

Explanation follows regarding internal configuration of the foreign currency exchange device 1.

The foreign currency exchange device 1 illustrated in FIG. 1 includes a control unit 10 serving as a controller, a touch panel unit 20, a banknote unit 30, a receipt unit 40, a journal unit 50, a medium reader unit 60 serving as a reader section, and a storage unit 70 serving as a first storage section.

The control unit 10 is configured around a Central Processing Unit (CPU). The control unit 10 controls respective units by executing a predetermined program read from a Read Only Memory (ROM), a Random Access Memory (RAM), and/or the storage unit 70 to perform processing relating to foreign currency exchange transactions.

The touch panel unit 20 displays screens such as a transaction type (buying transaction, selling transaction) selection menu screen, transaction operation screens, and transaction detail screens (exchange rates, transaction amounts, and the like), and accepts input information that has been input (selected) by a customer. Note that the touch panel unit 20 is not limited to a touch panel with an integrally combined operation section and display section, and an operation section and a display section may have different physical configurations to each other.

The banknote unit 30 has a function of taking in and storing banknotes inserted by a customer, and also a has a function of paying out stored banknotes to a customer. Note that although the present exemplary embodiment describes an example in which cash is only handled in the form of banknotes, a configuration in which cash may also be handled in the form of coins (a configuration including a coin unit) is also possible.

The receipt unit 40 dispenses user transaction details (exchange details) printed on a paper.

The journal unit 50 retains a history of internal operation statuses and transaction details.

The medium reader unit 60 reads data in a contact or non-contact manner from a passport, or from an ID card issued by the country in which the foreign currency exchange device 1 is installed (for example a My Number card in the case of Japan, or an e-KTP card in the case of Indonesia). For example, the medium reader unit 60 performs Optical Character Recognition (OCR) conversion on image data of an image scanned by a scanner in order to read data held on the medium. Note that passports and ID cards are examples of a medium.

The storage unit 70 stores processing programs and the like that are executed by the control unit 10, and is, for example, configured by flash memory and/or a HDD. The storage unit 70 holds saved individual user exchange amount data D in which total exchange amounts of buying transactions and selling transactions are stored by individual (user), and also holds a limit amount L1 representing an exchange transaction limit amount for a predetermined time period (for example, 1 day).

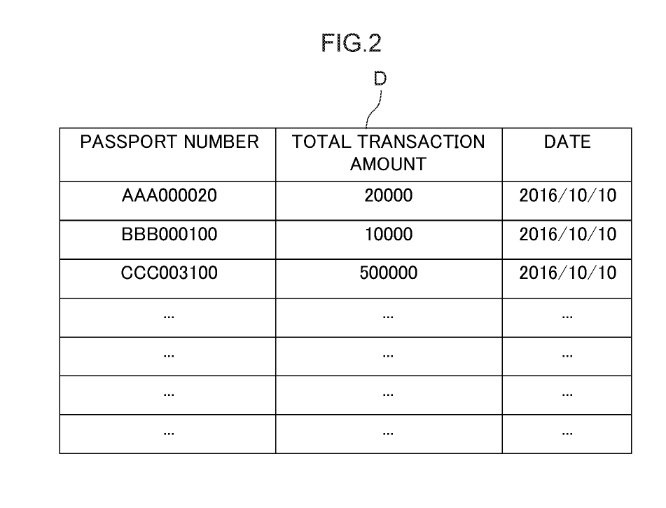

FIG. 2 is an explanatory diagram illustrating an example of the saved individual user exchange amount data of the first exemplary embodiment.

In FIG. 2, the saved individual user exchange amount data D includes the fields “passport number” for identifying an individual recorded on a passport, a “total transaction amount” that is incremented by the transaction amount each time an exchange transaction (buying transaction, selling transaction) is performed, and “date” indicating the date on which the first exchange transaction was performed using the foreign currency exchange device 1. The fields held in the saved individual user exchange amount data D are not limited thereto, and other fields may be added, for example the transacted currency type. Note that calculation of the total transaction amount may be a calculated using either the foreign currency or the domestic currency as the reference currency.

The examples of passport numbers given in FIG. 2 (AAA000020 etc.) are fictitious values given for the purposes of explanation, and do not relate to an actual numbering system.

Details of processing in which the control unit 10 references the saved individual user exchange amount data D and the limit amount L1 to determine whether or not to actually perform an exchange will be made clear in the description of the operation below.

### (A-2) Operation of the First Exemplary Embodiment

Explanation follows regarding operation of the foreign currency exchange device 1 of the first exemplary embodiment with the configuration described above. The following explanation takes a passport as an example of a medium read by the medium reader unit 60. In this example, cash is only exchanged in the form of banknotes.

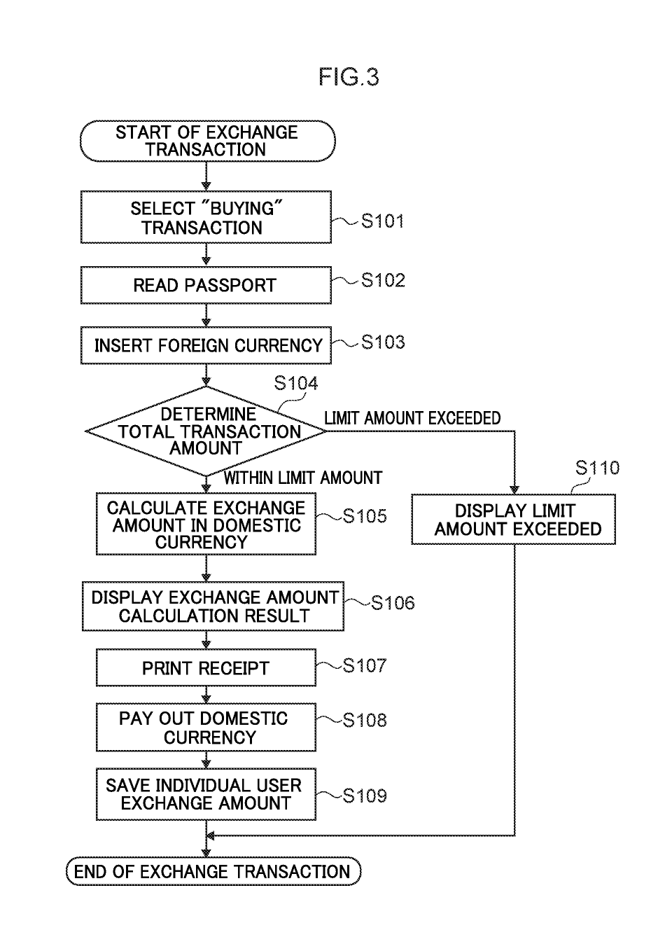

FIG. 3 is a flowchart illustrating exchange transaction (buying transaction) processing of the foreign currency exchange device of the first exemplary embodiment.

The control unit 10 accepts user selection of a buying transaction from an exchange transaction type selection screen on the touch panel unit 20 (S101).

The control unit 10 displays, for example, a passport reading screen on the touch panel unit 20 to prompt placement (insertion) of a passport at a predetermined location in the medium reader unit 60 in order to read the passport (S102). The medium reader unit 60 then reads data from the proffered passport. Data (the passport number and the like) read from the user's passport by the medium reader unit 60 is passed to the control unit 10.

After foreign currency has been inserted through a predetermined location on the banknote unit 30 (S103), the control unit 10 accepts a finalized amount (transaction amount).

The control unit 10 determines whether or not the total of past transaction amounts in data corresponding to the read passport number read of the saved individual user exchange amount data D plus the total of a current transaction amount (a combined transaction amount) exceeds the set limit amount L1 (S104). In cases in which it is determined that the combined transaction amount exceeds the limit amount L1, the control unit 10 transitions to the processing of step S110, described later. In cases in which it is determined that the combined transaction amount does not exceed the limit amount L1, the following processing is performed.

The control unit 10 calculates an exchange amount from the foreign currency to the domestic currency based on the prevailing exchange rate, and displays the result of this calculation on the touch panel unit 20 (S105, S106). The control unit 10 then issues a receipt printed with the transaction details using the receipt unit 40, and performs processing to pay out the finalized domestic currency using the banknote unit 30 (S107, S108).

The control unit 10 performs processing to add the current transaction amount to the “total transaction amount” in the saved individual user exchange amount data D (S109). Note that in cases in which, for example, the limit amount L1 is managed in 1 day units, if the date has changed the previous day is cleared before calculating the total transaction amount.

In cases in which the control unit 10 determines that the combined transaction amount exceeds the limit amount L1 in the processing of step S104 described above, the transaction is canceled (i.e., the inserted foreign currency is returned), and the touch panel unit 20 displays the fact that the amount to be exchanged exceeds the limit amount (S110).

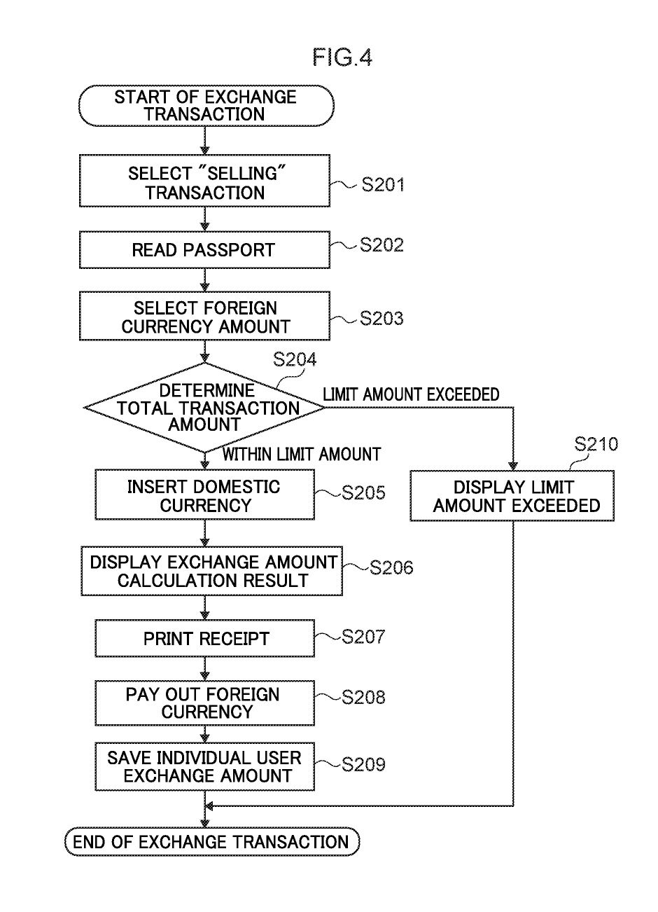

FIG. 4 is a flowchart illustrating exchange transaction (selling transaction) processing of the foreign currency exchange device of the first exemplary embodiment.

The control unit 10 accepts user selection of a selling transaction from the exchange transaction type selection screen on the touch panel unit 20 (S201).

The processing of step S202 is similar to the processing of step S102 described above, and so explanation thereof is omitted.

The control unit 10 displays a screen for selection of a foreign currency amount on the touch panel unit 20, and accepts input of a desired amount from the user (S203).

The processing of step S204 is similar to the processing of step S104 described above, and so explanation thereof is omitted.

The control unit 10 accepts insertion of domestic currency to the value of the current transaction amount through a predetermined location on the banknote unit 30 (S205).

The processing of steps S206 to S210 is similar to the processing of steps S106 to S110 described above, and so explanation thereof is omitted.

### (A-3) Effects of the First Exemplary Embodiment

The foreign currency exchange device 1 of the present disclosure reads a medium and manages the total transaction amount (holds the saved individual user exchange amount data D) for the individual user, enabling exchange transactions to be limited according to limit amounts set by country.

### (B) Second Exemplary Embodiment

Detailed explanation follows regarding a second exemplary embodiment of an automatic transaction device and an automatic transaction system of the present disclosure, with reference to the drawings. The present exemplary embodiment describes an example in which the automatic transaction system of the present disclosure is applied to a foreign currency exchange system.

### (B-1) Configuration of the Second Exemplary Embodiment

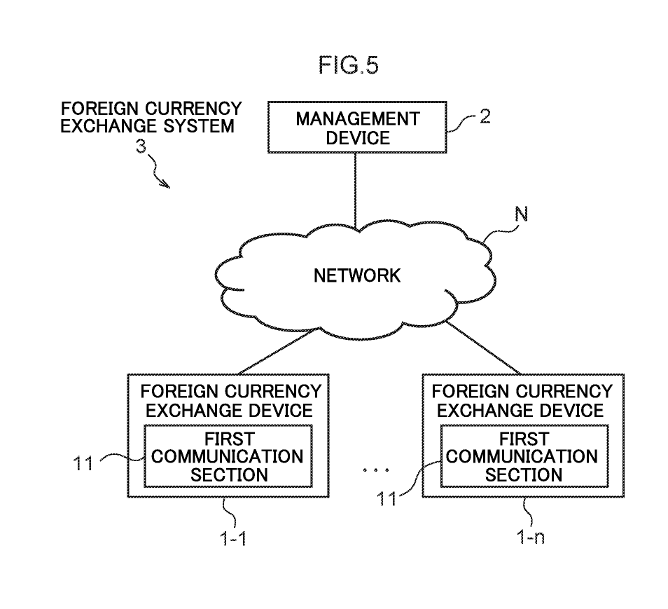

FIG. 5 is a block diagram illustrating an overall configuration of a foreign currency exchange system of the second exemplary embodiment. A foreign currency exchange system 3 illustrated in FIG. 5 is configured including a network N, plural foreign currency exchange devices 1-1 to 1-N (N being a positive integer) capable of connecting to the network N, and a management device 2.

The network N is a communication network capable of communicating data relating to foreign currency exchange transactions, and is, for example, a dedicated network. The network N may also be configured by a public network as long as it is capable of communicating data relating to foreign currency exchange transactions.

A foreign currency exchange device 1-n (1≤n≤N) of the second exemplary embodiment is, for example, a foreign currency exchange device installed in an airport, railway station, financial institution, hotel, or the like. The basic configuration of the foreign currency exchange device 1-n of the second exemplary embodiment is similar to that of the foreign currency exchange device 1 of the first exemplary embodiment illustrated in FIG. 1 and described above, but differs in that it is capable of communicating with the management device 2 over the network N (i.e., in being provided with a first communication section 11), and in that the limit amount L1 and the saved individual user exchange amount data D are not held in the storage unit 70. Operation of the foreign currency exchange device 1-n of the second exemplary embodiment differs in part from that of the foreign currency exchange device 1 of the first exemplary embodiment, as will be made clear in the description of the operation below.

The management device 2 is a device that collects and manages data relating to exchange transactions performed by the foreign currency exchange device 1-n through the network N.

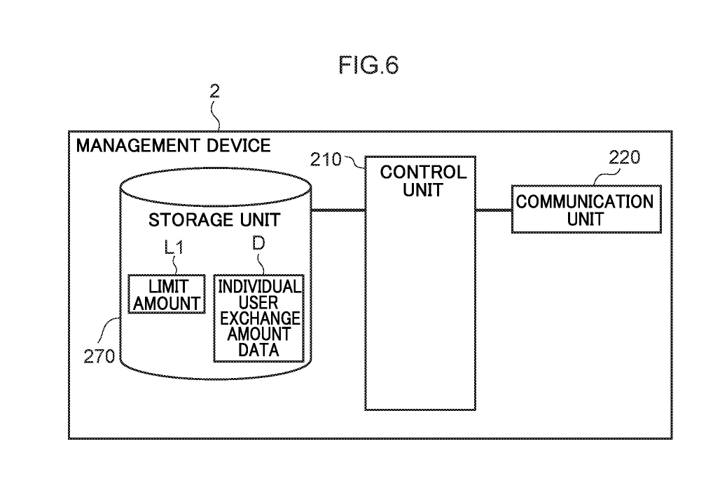

FIG. 6 is a block diagram illustrating configuration of the management device of the second exemplary embodiment.

The management device 2 illustrated in FIG. 6 includes a control unit 210 serving as a determination section, a communication unit 220 serving as a second communication section, and a storage unit 270 serving as a second storage section.

The control unit 210 is configured around a CPU, and reads and executes a predetermined program from ROM and/or the storage unit 270 to perform processing relating to foreign currency exchange transactions. The control unit 210 receives information identifying an individual user and transaction amount information for each individual from the foreign currency exchange device 1-n, and manages these information in the saved individual user exchange amount data D described above. The control unit 210 also references the saved individual user exchange amount data D to perform determination by comparing a combined transaction amount against the limit amount L1, and notifies the foreign currency exchange device 1-n of whether an exchange has been permitted or declined.

The communication unit 220 is a network interface for communicating information with the foreign currency exchange device 1-n.

### (B-2) Operation of the Second Exemplary Embodiment

Explanation follows regarding operation of the foreign currency exchange system 3 (foreign currency exchange device 1-n) of the second exemplary embodiment with the configuration described above.

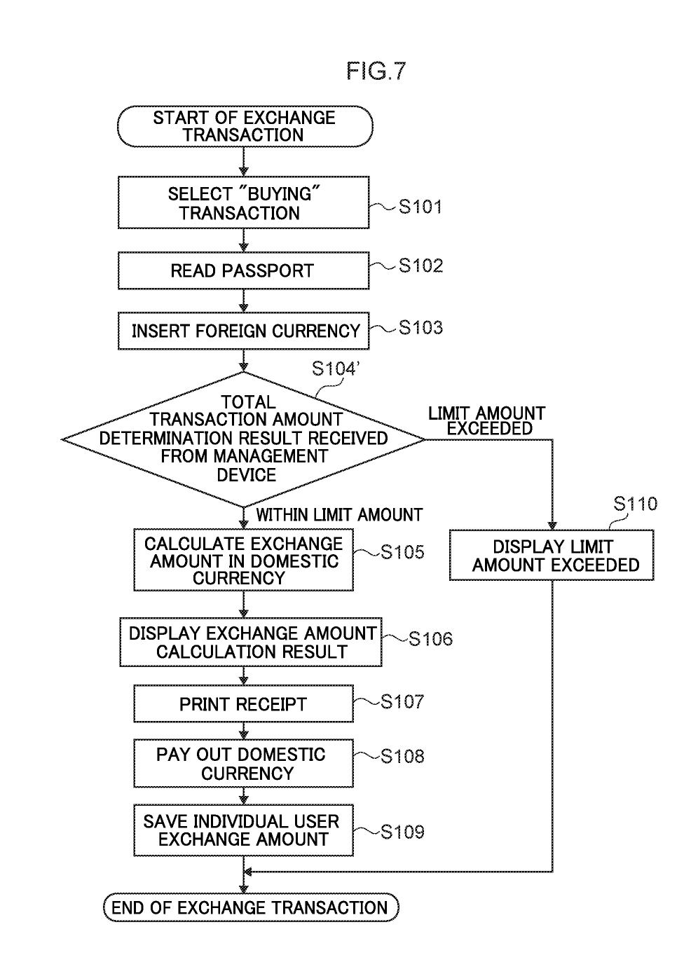

The basic flow of processing for a buying transaction of the foreign currency exchange device 1-n is similar to that of the processing illustrated in FIG. 3 and described above. However, unlike the first exemplary embodiment, some of the processing is performed by the management device 2, and explanation focuses on these points of difference (in particular the processing of step S104′). FIG. 7 is a flowchart illustrating exchange transaction (buying transaction) processing of the foreign currency exchange device of the second exemplary embodiment. In FIG. 7, processing with the same reference numerals as in FIG. 3 is similar in content to that described previously, and so explanation thereof is omitted.

After the processing of step S103, at step S104′ the foreign currency exchange device 1-n transmits the passport number and the inserted foreign currency amount (current transaction amount) to the management device 2. The management device 2 (control unit 210) then determines whether or not the total transaction amount in the data corresponding to the received passport number of the saved individual user exchange amount data D plus the total current transaction amount (combined transaction amount) exceeds the set limit amount L1. The management device 2 then transmits the determination result (i.e., whether or not the limit amount L1 has been exceeded) to the foreign currency exchange device 1-n. Based on the received determination result, the foreign currency exchange device 1-n transitions to the processing of either step S105 or step S110 described above. Note that the management device 2 updates the saved individual user exchange amount data D according to the determination result.

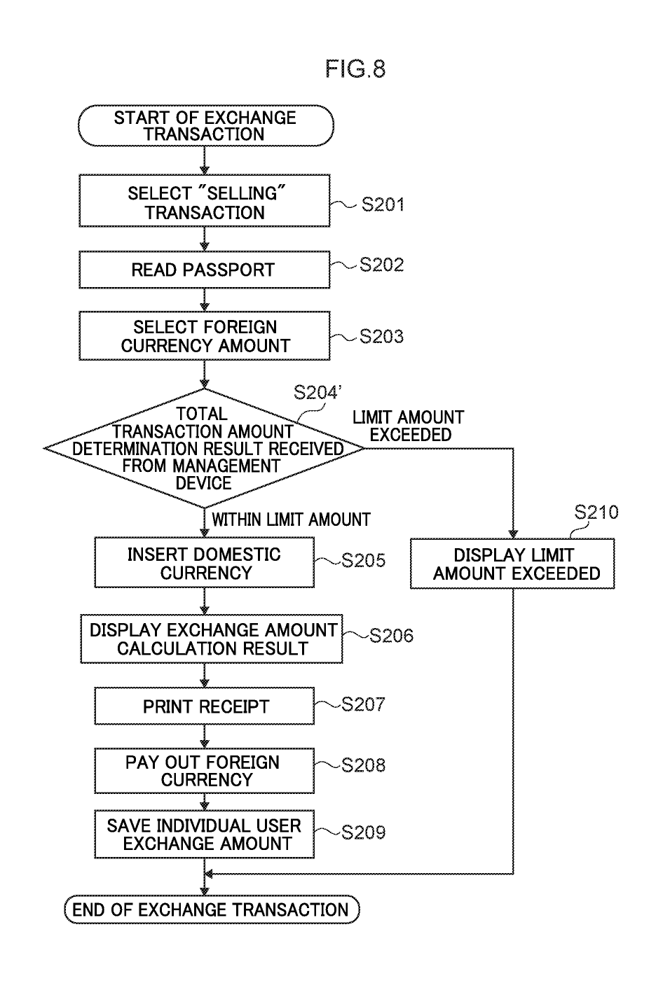

The basic flow of processing in a selling transaction of the foreign currency exchange device 1-n is similar to that illustrated in FIG. 4 and described above. However, unlike the first exemplary embodiment, some of the processing is performed by the management device 2, and explanation focuses on these points of difference (in particular the processing of step S204′). FIG. 8 is a flowchart illustrating exchange transaction (selling transaction) processing of the foreign currency exchange device of the second exemplary embodiment. In FIG. 8, processing with the same reference numerals as in FIG. 4 is similar in content to that described previously, and so explanation thereof is omitted.

After the processing of step S203, at step S204′ the foreign currency exchange device 1-n transmits the passport number and the input foreign currency amount (the current transaction amount) to the management device 2. The management device 2 (control unit 210) determines whether or not the total transaction amount in the data corresponding to the received passport number of the saved individual user exchange amount data D plus the total current transaction amount (combined transaction amount) exceeds the set limit amount L1. The management device 2 then transmits the determination result (i.e., whether or not the limit amount L1 has been exceeded) to the foreign currency exchange device 1-n. Based on the received determination result, the foreign currency exchange device 1-n transitions to the processing of either step S205 or step S210 described above. Note that the management device 2 updates the saved individual user exchange amount data D according to the determination result.

### (B-3) Effects of the Second Exemplary Embodiment

The second exemplary embodiment exhibits the following effects in addition to those of the first exemplary embodiment.

In the first exemplary embodiment, each individual foreign currency exchange device 1 calculates the limit amount independently. However, in the second exemplary embodiment, since individual customer transaction amounts are centrally managed by the management device 2, the limit amount may be calculated based on the transaction amounts from plural foreign currency exchange devices in cases in which the same person exchanges using plural foreign currency exchange devices.

### (C) Third Exemplary Embodiment

Detailed explanation follows regarding a third exemplary embodiment of an automatic transaction device and automatic transaction system of the present disclosure, with reference to the drawings. The present exemplary embodiment describes an example in which the automatic transaction device of the present disclosure is applied to a foreign currency exchange device.

### (C-1) Configuration of the Third Exemplary Embodiment

The configuration of the foreign currency exchange device 1 of the third exemplary embodiment may be illustrated by FIG. 1 and FIG. 2, similarly to the first exemplary embodiment.

The following explanation focuses on differences between the configuration of the foreign currency exchange device 1 of the third exemplary embodiment and that of the first exemplary embodiment.

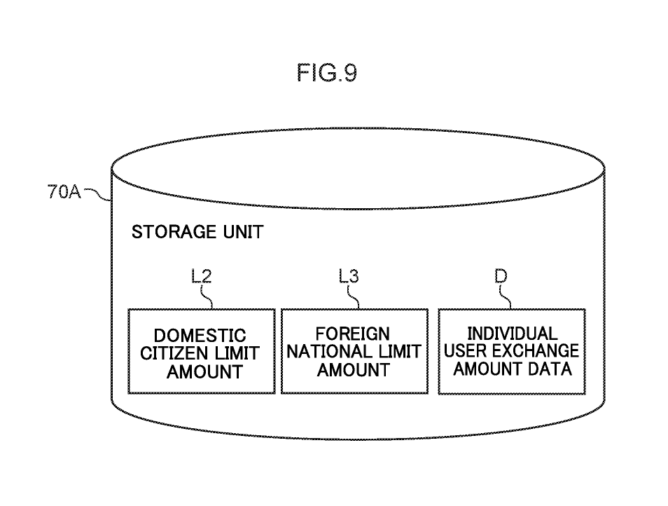

The foreign currency exchange device 1 (storage unit 70) of the first exemplary embodiment is provided with a single limit amount L1 representing an exchange transaction limit amount. As illustrated in FIG. 9, the foreign currency exchange device 1 (storage unit 70A) of the third exemplary embodiment is provides with two limit amounts, namely, a domestic citizen limit amount L2 representing a limit amount for exchange transactions by domestic citizens, and a foreign national limit amount L3 representing a limit amount for exchange transactions by foreign nationals. The control unit 10 of the third exemplary embodiment decides which limit amount of the domestic citizen limit amount L2 or the foreign national limit amount L3 should be applied based on nationality information read from a passport, and determines whether to permit or decline exchange transactions similarly to in the first exemplary embodiment.

### (C-2) Operation of the Third Exemplary Embodiment

Next, explanation follows regarding operation of the foreign currency exchange device 1 of the third exemplary embodiment with the configuration described above.

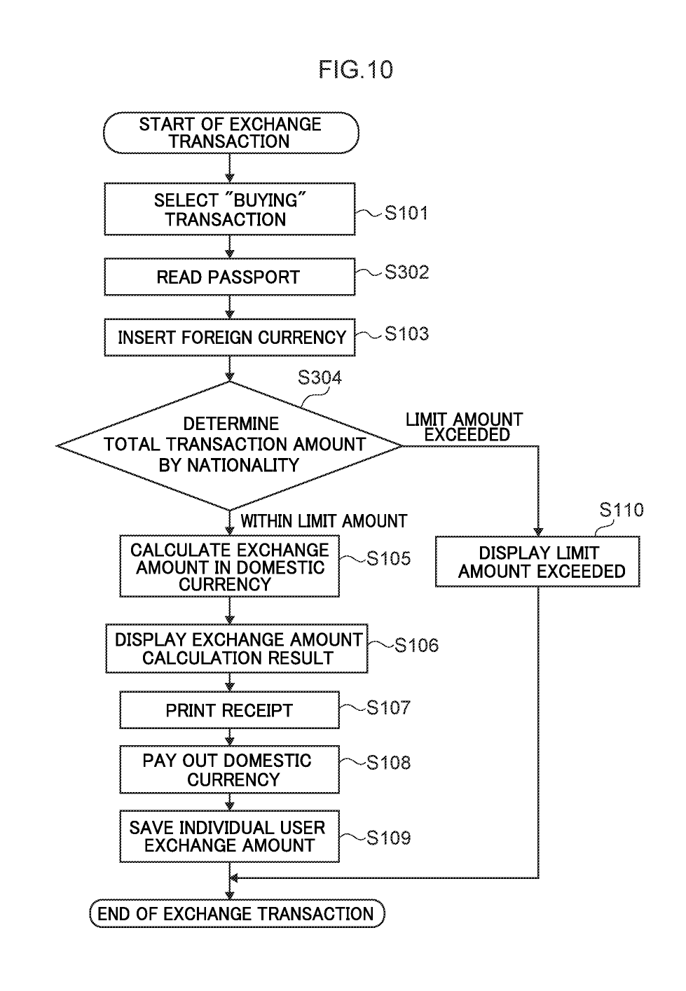

FIG. 10 is a flowchart illustrating exchange transaction (buying transaction) processing of the foreign currency exchange device of the third exemplary embodiment. In FIG. 10, processing with the same reference numerals as in FIG. 3 is similar in content to that described previously, and so explanation thereof is omitted. Explanation follows regarding processing specific to FIG. 10 (i.e., step S302 and step S304).

The medium reader unit 60 reads not only a passport number but also nationality information, and passes the read information to the control unit 10 (S302). For example, the medium reader unit 60 acquires information from a passport in an optical or non-contact manner and passes the acquired information to the control unit 10 (S302).

The control unit 10 determines whether or not the total past transaction amount in the data corresponding to the read passport number of the saved individual user exchange amount data D plus the total of the current transaction amount (combined transaction amount) exceeds the set limit amount (i.e., the domestic citizen limit amount L2 or the foreign national limit amount L3) (S304). In cases in which the combined transaction amount is determined to exceed the limit amount, the control unit 10 transitions to the processing of step S110, described later, and in cases in which the combined transaction amount is determined not to exceed the limit amount, the control unit 10 performs the following processing. Note that the control unit 10 decides whether to apply the domestic citizen limit amount L2 or the foreign national limit amount L3 as the limit amount based on the nationality information of the passport read in the processing of step S302 described above. For example, by setting the value of the domestic citizen limit amount L2 to 0, it is possible to set limitless exchange for users who are domestic citizens. Conversely, by setting the value of the foreign national limit amount L3 to 0, it is possible to set limitless exchange for users who are foreign nationals (visitors from abroad).

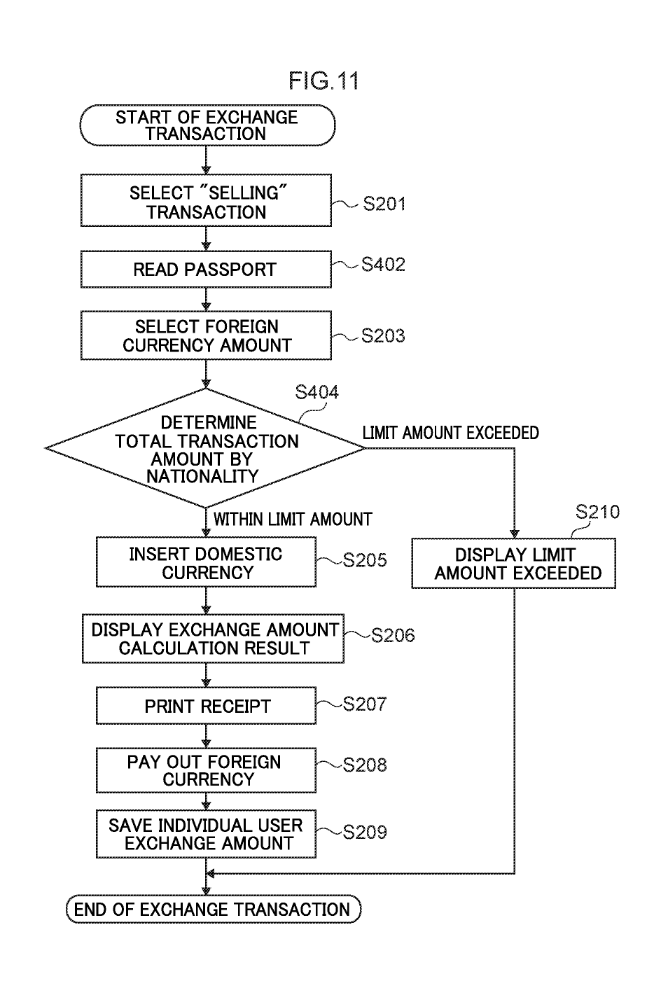

FIG. 11 is a flowchart illustrating exchange transaction (selling transaction) processing of the foreign currency exchange device of the third exemplary embodiment. In FIG. 11, processing with the same reference numerals as in FIG. 4 is similar in content to that described previously, and so explanation thereof is omitted. Moreover, processing specific to FIG. 11 (i.e., steps S402 and S404) is similar to that of steps S302 and S304 described above, and so explanation thereof is omitted.

### (C-3) Effects of the Third Exemplary Embodiment

The third exemplary embodiment exhibits the following effects in addition to those of the first exemplary embodiment.

In the third exemplary embodiment, since plural limit amounts are provided and are applied based on the nationality of the user, it is possible to apply different limit amounts for users depending on whether the user is a domestic citizen or a foreign national.

### (D) Other Exemplary Embodiments

The present disclosure is not limited to the exemplary embodiments described above, and modified exemplary embodiments such as those described below may be applied.

(D-1) Although an example has been given in which a passport is applied as the medium used to identify an individual user in the exemplary embodiments described above, personal cards issued by a country, such as My Number cards (in Japan) or e-KTP cards (in Indonesia), may be applied as media used to identify an individual user.

(D-2) Although an example of operation has been given in which the two limit amounts of the domestic citizen limit amount L2 for domestic citizens and the foreign national limit amount L3 for foreign nationals are provided as exchange transaction limit amounts in the third exemplary embodiment, plural limit amounts may similarly be provided in the management device 2 of the second exemplary embodiment to achieve operation similar to that of the third exemplary embodiment.

1. An automatic transaction device that performs an exchange transaction to exchange cash of a first currency for cash of a second currency, the automatic transaction device comprising:
a reader section that reads medium-held information that is held on a medium and that includes at least information identifying an individual user;
a controller that, based on the medium-held information read by the reader section, performs control to cancel a current exchange transaction according to whether or not a sum of a total of a transaction amount of a user performing one or more exchange transactions within a predetermined time period, and a transaction amount of the current exchange transaction, exceeds a predetermined upper limit amount.

2. The automatic transaction device of claim 1, wherein the reader section includes a scanner that reads image data of an image on the medium and the reader section performs OCR conversion on the image data of the image in order to acquire the medium-held information.

3. The automatic transaction device of claim 1, wherein:
the predetermined upper limit amount is applied to the control to cancel in a case in which the user has a predetermined nationality, and
the controller determines whether or not the user has the predetermined nationality based on nationality information included in the medium-held information.

4. An automatic transaction system comprising:
a plurality of automatic transaction devices that perform an exchange transaction to exchange cash of a first currency for cash of a second currency; and
a management device,
wherein each of the automatic transaction devices comprises:
a reader section that reads medium-held information that is held on a medium and that includes at least information identifying an individual user,
a first communication section that transmits, to the management device, the medium-held information and information indicating a transaction amount of a current exchange transaction, and that receives, from the management device, determination information to determine whether or not to continue with the current exchange transaction, and
a controller that performs control to cancel the current exchange transaction based on the determination information; and
wherein the management device comprises:
a second communication section that receives, from one or more of the automatic transaction devices, the medium-held information and the information indicating the transaction amount of the current exchange transaction, and that transmits the determination information to the one or more of the automatic transaction devices,
a storage section that stores a transaction amount of one or more exchange transactions that has been performed by a user within a predetermined time period using any of the automatic transaction devices, and
a determination section that, based on the medium-held information, generates the determination information as to whether or not to continue with the current exchange transaction depending on whether or not a sum of the transaction amount and a transaction amount of the current exchange transaction exceeds a predetermined upper limit amount.

5. The automatic transaction system of claim 4, wherein:
the predetermined upper limit amount is applied to the control to cancel or when generating the determination information, in a case in which the user has a predetermined nationality, and information included in the medium-held information.

6. The automatic transaction device of claim 1, further comprising a touch panel or a plurality of buttons, wherein the transaction amount of the current exchange transaction is input, by the user, via the touch panel or the plurality of buttons.

7. The automatic transaction device of claim 1, wherein the reader section comprises a scanner that optically acquires the medium-held information from the medium.

8. The automatic transaction device of claim 1, wherein the predetermined upper limit amount comprises:
a first upper limit amount that is applied to the control to cancel in a case in which the user has a first nationality; and
a second upper limit amount that is applied to the control to cancel in a case in which the user has a second nationality, and
whether or not the user has the first or second nationality is determined based on nationality information included in the medium-held information.

9. The automatic transaction device of claim 1, further comprising a communication section that communicates with a management device, wherein the total of the transaction amount of the user is stored in the management device, and the communication section receives the total of the transaction amount of the user from the management device.

10. The automatic transaction device of claim 9, wherein:
the communication section transmits the medium-held information to the management device, and
the total of the transaction amount of the user is identified according to the medium-held information.

11. The automatic transaction device of claim 9, further comprising a storage section that stores a sum of the total of the transaction amount of the user and the transaction amount of the current exchange transaction, in a case in which the sum is equal to or less than the predetermined upper limit amount.

12. The automatic transaction device of claim 9, wherein a sum of the total of the transaction amount of the user and the transaction amount of the current exchange transaction is stored in the management device, in a case in which the sum is equal to or less than the predetermined upper limit amount.

13. An automatic transaction device comprising:
a reader section that acquires medium-held information that is held on a medium and that includes at least identify information of a user;
a first communication section that transmits, to an external management device, a transaction amount of a current exchange transaction and the medium-held information, and receives, from the management device, determination information to determine whether or not to continue with the current exchange transaction; and
a controller that performs control to cancel the current exchange transaction based on the determination information,
wherein the determination information comprises information indicating whether or not a sum of a total of a transaction amount of the user performing one or more exchange transactions within a predetermined time period, and the transaction amount of the current exchange transaction, exceeds a predetermined upper limit amount.

14. The automatic transaction device of claim 13, wherein:
the predetermined upper limit amount is applied to the control to cancel in a case in which the user has a predetermined nationality, and
the controller determines whether or not the user has the predetermined nationality based on nationality information included in the medium-held information.

15. The automatic transaction device of claim 2, wherein:
the predetermined upper limit amount is applied to the control to cancel in a case in which the user has a predetermined nationality, and
the controller determines whether or not the user has the predetermined nationality based on nationality information included in the medium-held information.

16. The automatic transaction device of claim 2, wherein the predetermined upper limit amount comprises:
a first upper limit amount that is applied to the control to cancel in a case in which the user has a first nationality; and
a second upper limit amount that is applied to the control to cancel in a case in which the user has a second nationality, and
whether or not the user has the first or second nationality is determined based on nationality information included in the medium-held information.
